(19) United States
(12) Patent Application Publication
(10) Pub. No.: US 2004/0257441 A1
(43) Pub. Date: Dec. 23, 2004

(54) Digital imaging system for airborne applications

(75) Inventors: William L. Pevear, Marblehead, MA (US); James E. Kain, Shalimar, FL (US)

Correspondence Address: KUDIRKA & JOBSE, LLP, ONE STATE STREET, SUITE 800, BOSTON, MA, 02109, US

(73) Assignee: Geovantage, Inc., Swampscott, MA

(21) Appl. No.: 10/821,119

(22) Filed: Apr. 8, 2004

Related U.S. Application Data
(63) Continuation-in-part of application No. 10/228,863, filed on Aug. 27, 2002.
(60) Provisional application No. 60/315,799, filed on Aug. 29, 2001.

(51) Int. Cl. H04N 7/18

(52) U.S. Cl. 348/144

(57) ABSTRACT

An aerial imaging system has an image storage medium locatable in an aircraft, a controller that controls the collection of image data and stores it in the storage medium and a digital camera assembly that collects image data from a region to be imaged. An inertial measurement system (IMU) is fixed in position relative to the camera assembly and detects rotational position of the aircraft, and a GPS receiver detects absolute position of the aircraft. The camera assembly includes multiple cameras that are calibrated relative to one another to generate compensation values that may be used during image processing to minimize camera-to-camera aberrations. Calibration of the cameras relative to the IMU provides compensation values to minimize rotational misalignments between image data and IMU data. A modular camera assembly may also be used that allows multiple camera modules to be easily aligned, mounted and replaced.

### RELATED APPLICATIONS

This application is a continuation-in-part of U.S. patent application Ser. No. 10/228,863, filed Aug. 27, 2002, which takes priority from U.S. Provisional Patent application Ser. No. 60/315,799, filed Aug. 29, 2001.

### FIELD OF THE INVENTION

This invention relates generally to the collection of terrain images from high altitude and, more specifically, to the collection of such images from overflying aircraft.

### BACKGROUND OF THE INVENTION

The use of cameras on aircraft for collecting imagery of the overflown terrain is in wide practice. Traditional use of film-based cameras together with the scanning of the film and the use of pre-surveyed visible ground markers (ground control points) for “geo-registration” of the images is a mature technology. Geo-registration is the location of visible features in the imagery with respect to geodetic earth-fixed coordinates. More recently, the field has moved from film cameras to digital cameras, thereby eliminating the requirements for film management, film post-processing, and scanning steps. This, in turn, has reduced operational costs and the likelihood of geo-registration errors introduced by the film-handling steps.

Additional operational costs of image collection can result from the use of integrated navigation systems that precisely determine the attitude and position of the camera in a geodetic reference frame. By doing so, the requirements for pre-surveying ground control points is removed. Moreover, the integrated systems allow for the automation of all image frame mosaicking, thus reducing the time to produce imagery and the cost of the overall imagery collection.

Today, global positional systems (GPS) and inertial motion sensors (rate gyros and accelerometers) are used for computation of position and attitude. Such motion sensors are rigidly attached relative to the cameras so that inertial sensor axes can be related to the camera axes with three constant misalignment angles. The GPS/inertial integration methods determine the attitude of the inertial sensor axes. The fixed geometry between the motion sensing devices and the camera axes thus allows for the determination of boresight axes of the cameras.

Traditionally, the mounting of airborne cameras has required special aircraft modifications, such as have holes in the bottom of each aircraft fuselage or some similarly permanent modification. This usually requires that such a modified aircraft be dedicated to imaging operations. One prior art method, described in detail in U.S. Pat. No. 5,894,323, uses an approach in which the camera is attached to an aircraft cargo door. This method makes use of a stabilizing platform in the aircraft on which the imaging apparatus is mounted to prevent pitch and roll variations in the camera positioning. The mounting of the system on the cargo door is quite cumbersome, as it requires removal of the cargo door and its replacement with a modified door to which the camera is mounted.

### SUMMARY OF THE INVENTION

In accordance with the present invention, an aerial imaging system is provided that includes a digital storage medium locatable within an aircraft and a controller that controls the collection of image data and stores it in the storage medium. A digital camera assembly collects the image data while the aircraft is in flight, imaging a region of interest and inputting the image data to the controller.

The camera assembly is rigidly mountable to a preexisting mounting point on an outer surface of the aircraft. In one embodiment, the mounting point is a mount for an external step on a high-wing aircraft such as a Cessna 152, 172, 182 or 206. In such a case, an electrical cable connecting the camera assembly and the controller passes through a gap between a door of the aircraft and the aircraft fuselage. In another embodiment, the mounting point is an external step on a low-wing aircraft, such as certain models of Mooney, Piper and Beech aircraft. In those situations, the cable may be passed through a pre-existing passage into the interior of the cabin.

In one embodiment of the invention, the controller is a digital computer that may have a removable hard drive. An inertial measurement unit (IMU) may be provided that detects acceleration and rotation rates of the camera assembly and provides an input signal to the controller. This IMU may be part of the camera assembly, being rigidly fixed in position relative thereto. A global positioning system (GPS) may also be provided, detecting the position of the imaging system and providing a corresponding input to the controller. In addition, a steering bar may be included that receives position and orientation data from the controller and provides a visual output to a pilot of the aircraft that is indicative of deviations of the aircraft from a predetermined flight plan.

In one embodiment, the camera assembly is made up of multiple monochrome digital cameras. In order to provide an adequate relative calibration between the multiple cameras, a calibration apparatus may be provided. This apparatus makes use of a target having predetermined visual characteristics. A first camera is used to image the target, and the camera data is then used to establish compensation values for that camera that may be applied to subsequent images to minimize camera-to-camera aberrations. The target used may have a plurality of prominent visual components with predetermined coordinates relative to the camera assembly. A data processor running a software routine compares predicted locations of the predetermined visual characteristics of the target with the imaged locations of those components to determine a set of prediction errors. The prediction errors are then used to generate parameter modifications that may be applied to collected image data.

During the calibration process, data may be collected for a number of different rotational positions of the camera assembly relative to a primary optical axis between a camera being calibrated and the target. The predicted locations of the predetermined visual characteristics of the targets may be embodied in a set of image coordinates that correspond to regions within an image at which images of the predetermined visual characteristics are anticipated. By comparison of these coordinates to the actual coordinates in the image data corresponding to the target characteristics, the prediction errors may be determined. Using these prediction errors in combination with an optimization cost function, such as in a Levenburg-Marquart routine, a set of parameter adjustments may be found that minimizes the cost function. In establishing the compensation values, unit vectors may be assigned to each pixel-generating imaging element of a camera being calibrated. As mentioned above, with multiple cameras, different cameras may be calibrated one by one, with one camera in the camera assembly may be selected as a master camera. The other cameras are then calibrated to that master camera.

In addition to the calibration of the cameras relative to each other, the camera assembly may be calibrated to the IMU to minimize rotational misalignments between them. A target with predetermined visual characteristics may again be used, and may be located on a level plane with the camera to which the IMU is calibrated (typically a master camera). The target is then imaged, and the image data used to precisely align the rotational axes of the camera with the target. Data is collected from the IMU, the position of which is fixed relative to the camera assembly. By comparing the target image data and the IMU data, misalignments between the two may be determined, and compensation values may be generated that may be applied during subsequent image collection to compensate for the misalignments.

The camera-to-IMU calibration may be performed for a number of different rotational positions (e.g., 0°, 90°, 180° and 270°) about a primary optical axis of the camera to which the IMU is calibrated. The calibration may determine misalignments in pitch, yaw and roll relative to the primary optical axis. The calibration may also be performed at two angular positions 180° relative to each other and the IMU data collected at those two positions differenced to remove the effects of IMU accelerometer bias.

In another alternative embodiment, a camera assembly may consist of a plurality of camera modules, each of which is independent, and may be swapped in and out of the overall camera assembly. Each module can be constructed from a monolithic block of material, such as aluminum, into which are formed a plurality of parallel lens cavities. A filter retainer may be connected to the front of the block that retains a plurality of filters, each of which filters light received by a corresponding lens. The mounting block and the filter retainers can be connected together to form an airtight seal, and a space between them may be evacuated. A receptacle may be located within the airtight space in which a desiccant may be located.

Imaging for this camera assembly can be done using a plurality of photodetectors, such as a photosensitive charge-coupled devices, that are each located behind a respective lens of the mounting block. Each of the photodetectors may be mounted on a separate circuit board, with each circuit board being fixed relative to the mounting block. A circuit board spacer can also be used between the mounting block and the circuit boards. The circuit boards are connected to a host processor via a serial data connection. The serial data connection may use a format that allows single cable connection from each of the circuit boards to a data hub, and a single connection from the data hub of a first circuit board to the host processor. An additional cable can also connect the data hub of the first circuit board to a data hub of a second circuit board, thus allowing a plurality of circuit boards to be interconnected in a daisy chain configuration, with all of the boards connected to the host processor via a single cable connection.

The camera assembly, along with other components such as the IMU, GPS boards and IMU/GPS/camera-trigger synchronization board, can be located within an aerodynamic pod that is mounted to the outside of an aircraft. The pod may have an outer shape, such as a substantially spherical front region, that minimizes drag on the pod during flight. The pod may be mounted to any of a number of different mounting locations on the aircraft, such as a step mount on a landing strut, on a wing strut, or on the base of the aircraft body. A single cable can be used to connect all of the components in the pod to a host processor within the aircraft cabin via an access port in the aircraft body, or via a space between the aircraft door and the body.

### BRIEF DESCRIPTION OF THE DRAWINGS

The above and further advantages of the invention may be better understood by referring to the following description in conjunction with the accompanying drawings in which:

FIG. 1 is a perspective view of an aircraft using an aerial imaging system according to the invention;

FIG. 2 is a perspective view of a mounted camera assembly of an imaging system as shown in FIG. 1;

FIG. 3 is a perspective view of the components of an imaging system according to the invention;

FIG. 4 is a flow diagram showing the steps for determining camera-to-camera misalignments in an imaging system according to the invention;

FIG. 5 is a flow diagram showing the steps for determining camera-to-IMU misalignments in an imaging system according to the invention;

FIG. 6 is a perspective view of an alternative mounting of a camera assembly of an imaging system according to the invention;

FIG. 7 is a perspective view of a pass-through for electrical cabling of the camera assembly shown in the embodiment of FIG. 6;

FIG. 8 is a schematic view of plurality of camera modules connected to a mounting bracket in an alternative embodiment of the invention;

FIG. 9 is a perspective view of a mounting block of one of the camera modules of FIG. 8;

FIG. 10 is a perspective view of the mounting block of FIG. 9 with a filter retainer attached in which a lens filter is mounted;

FIG. 11 is a perspective view of a rear side of the mounting block of FIG. 9;

FIG. 12 is a perspective view of the mounting block of FIG. 9 with a board spacer attached;

FIG. 13 is a perspective view of the mounting block and board spacer of FIG. 12 showing a camera board mounted in place;

FIG. 14 is a schematic view of the rear of a camera module with each of the camera boards connected to a central hub; and

FIG. 15 is a schematic view of an aerodynamic pod in which a camera assembly may be mounted.

### DETAILED DESCRIPTION

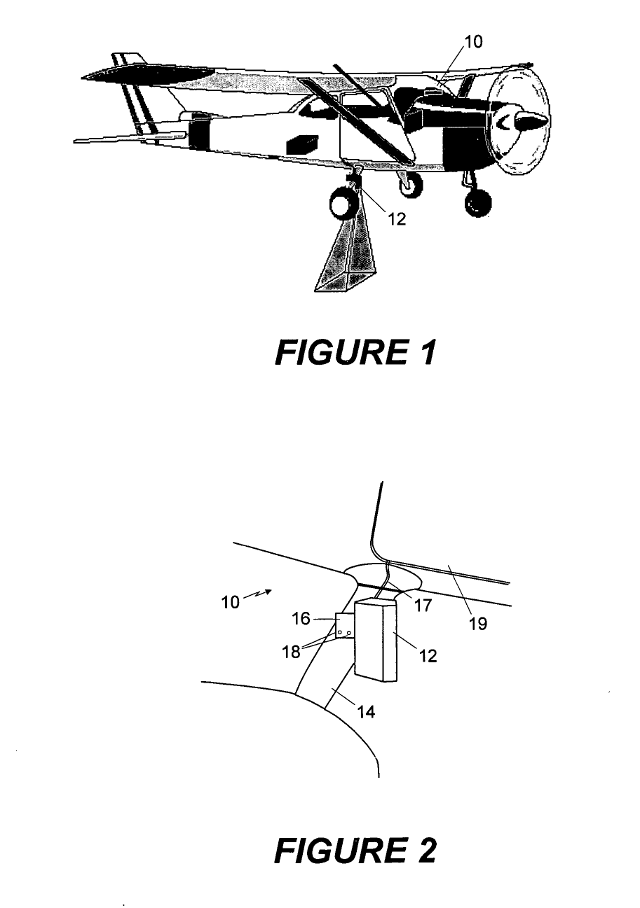

Shown in FIG. 1 is a view of a small airplane 10 as it might be used for image collection with the present invention. The plane shown in the figure may be any of a number of different high-wing type aircraft, such as the Cessna 152, 172, 182 or 206. In an alternative embodiment, discussed hereinafter, the invention may be used with low-wing aircraft as well. With the present invention in use, the aircraft may be flown over a region to be imaged, and collect accurate, organized digital images of the ground below.

Attached to the fixed landing gear of the airplane 10 is a digital camera assembly 12 of an aerial imaging system. The camera assembly 12 includes a set of (e.g., four) monochrome digital cameras, each of which has a different optical filter and images in a different desired imagery band. Also contained within the camera assembly 12 is an inertial measurement unit (IMU) that senses the precise acceleration and rotation rates of the camera axes. The IMU sensor, in conjunction with a global positioning system (GPS) antenna (discussed hereinafter) provide a data set that enables the determination of a precise geodetic attitude and position of the camera axes. Control of the imaging system is maintained by a controller that is located within the aircraft and to which the camera assembly 12 is electrically connected.

In an exemplary embodiment of the present invention, the camera assembly is conveniently connected to a preexisting mounting point on the right landing gear strut of the aircraft 10. This mounting point is part of the original equipment of the airplane, and is used to support a mounting step upon which a person entering the airplane could place a foot to simplify entry. However, the plane may also be entered without using the step, and the preexisting step mounting location is used by the present invention for supporting the camera assembly 12. This removes the need for unusual modifications to the aircraft for installing a camera, as has been common in the prior art.

In one exemplary embodiment, the camera assembly 12 is connected to the landing strut by two bolts. This attachment is shown in more detail in FIG. 2. The bolts 18 mate with bolt holes in a support 16 for the mounting step (not shown) that extends from right landing gear strut 14. This support plate is present in the original construction of the plane. To fasten the camera assembly 12 to the plane 10, the step is unbolted from the bolt holes in the support 16, and the camera assembly is bolted to the vacated bolt holes. As shown, the camera assembly 12 is oriented downward, so that during flight it is imaging the ground below the plane. An electrical cable 17 from the camera assembly 12 passes to the controller inside the aircraft through a gap between the aircraft door 19 and the aircraft body. No modification of the door is required; it is simply closed on the cable.

In the present invention, the orientation of the camera assembly is fixed relative to the orientation of the plane. Rather than attempt to keep the camera assembly oriented perpendicularly relative to the ground below, the system uses various sensor data to track the orientation of the camera assembly relative to the camera trigger times. Using a model constructed from this data, each pixel of each camera can be spatially corrected so as to ensure sub-pixel band alignment. This allows each pixel of each camera to be ray-traced onto a “digital elevation model” (DEM) of the overflown terrain. The pixel ray “impacts” are collected into rectangular cells formed from a client-specified coordinate projection. This provides both “geo-registration” and “ortho-registration” of each imagery frame. This, in turn, allows the creation of a composite mosaic image formed from all geo-registered frames. Notably, this is accomplished without a requirement for ground control points.

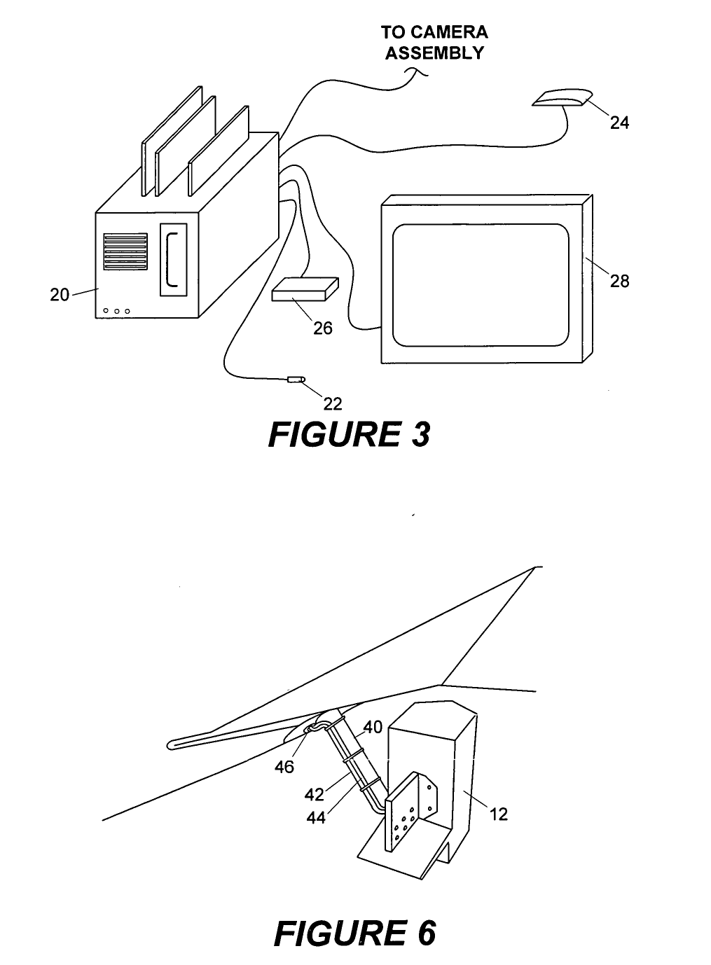

Shown in FIG. 3 are the components of a system according to the present invention. This system would be appropriate for installation on an unmodified Cessna 152/172/182 aircraft with fixed landing gear. The camera assembly is attached to the step mount as shown in FIG. 2. It is electrically connected to a main controller 20, which may be a customized personal computer. The electrical cable for the camera assembly, as discussed in more detail below, may pass through a space between the aircraft door and the aircraft body, as shown in FIG. 2. Also connected to the controller 20 are several other components used in the image acquisition process.

Since the entire imaging unit is made to be easily installed and removed from an airplane, there is no permanent power connection. In the system shown in FIG. 3, power is drawn from the airplane's electrical system via a cigarette lighter jack into which is inserted plug 22. Alternatively, a power connector may be installed on the plane that allows easy connection and disconnection of the imaging apparatus. The system also includes GPS antenna 24 which, together with a GPS receiver (typically internal to the main controller) provides real time positioning information to the controller, and heads-up steering bar 26, which provides an output to the pilot indicative of how the plane is moving relative to predetermined flight lines. Finally, a video display 28 is provided with touchscreen control to allow the pilot to control all the system components and to select missions. The screen may be a “daylight visible” type LCD display to ensure visibility in high ambient light situations.

The main controller 20 includes a computer chassis with a digital computer central processing unit, circuitry for performing the camera signal processing, a GPS receiver, timing circuitry and a removable hard drive for data storage and off-loading. Of course, the specific components of the controller 20 can vary without deviating from the core features of the invention. However, the basic operation of the system should remain the same.

The system of FIG. 3, once installed, is operated in the following manner. A predetermined flight plan is input to the system using a software interface that, for example, may be controlled via a touchscreen input on display 28. In flight, the controller 20 receives position data from GPS antenna 24, and processes it with its internal GPS receiver. An output from the controller 20 to the heads-up steering bar 26 is continuously updated, and indicates deviations of the flight path of the plane from the predetermined flight plan, allowing the pilot to make course corrections as necessary. The controller 20 also receives a data input from the IMU located in the camera assembly. The output from the IMU includes accelerations and rotation rates for the axes of the cameras in the camera assembly.

During the mission flight, the IMU data and the GPS data are collected and processed by the controller 20. The cameras of the camera assembly 12 are triggered by the controller based on the elapsed range from the last image. The field of view of the cameras overlap by a certain amount, e.g., 30%, although different degrees of overlap may be used as well. The maximum image collection rate is dictated by the rate of image data storage to the controller memory. The faster the data storage rate, the more overlap there may be between downrange images for a given altitude and speed. The cameras are provided with simultaneous image triggers, and are triggered based on an elapsed range from the last image which, in turn, is computed from the real-time GPS data to achieve a predetermined downrange overlap.

The camera assembly of the invention is rigidly fixed to the airplane in a predetermined position, typically vertical relative to the airplane's standard orientation during flight. Thus, the cameras of the assembly roll with the roll of the aircraft. However, the invention relies on the fact that the predominant aircraft motion is “straight-and-level.” Thus, the image data can be collected from a near-vertical aspect provided the camera frames are triggered at the exact points at which the IMU boresight axes are in a vertical plane. That is, the camera triggering is synchronized with the aircraft roll angle. Because the roll dynamics are typically high bandwidth, plenty of opportunities exist for camera triggering at the vertical aspect.

In one embodiment of the invention, a “down-range” threshold is set for triggering to ensure a good imagery overlap. That is, following one camera trigger, the aircraft is allowed to travel a certain distance further along the flight path, at which point the threshold is reached and the system begins looking for the next trigger point. The threshold takes into account the intended imagery overlap (e.g., thirty percent), and allows enough time, given the high frequency roll dynamics of the aircraft, to ensure that the next trigger will occur within the desired overlap range. Once the threshold point is reached, the system waits for the next appropriate trigger point (typically when the IMU boresight axes are in a vertical plane) and triggers the cameras.

By using IMU data and GPS data together, the invention is able to achieve “georegistration” without ground control. Georegistration in this context refers to the proper alignment of the collected image data with actual positional points on the earth's surface. With the IMU and GPS receiver and antenna, the precise attitude and position of the camera assembly is known at the time the cameras are triggered. This information may be correlated with the pixels of the image to allow the absolute coordinates on the image to be determined.

Although there is room for variation in some of the specific parameters of the present invention, an exemplary system may use a number of existing commercial components. For example, the system may use four digital cameras in the camera assembly, each of which has the specifications shown below in Table I.

TABLE 1

| | |
|---|---|
| Manufacturer | Sony SX900 |
| Image Device | ½″ IT CCD |
| Effective Picture Elements | 1,450,000 - 1392 (H) × 1040 (V) |
| Bits per pixel | 8 |
| Video Format | SVGA (1280 × 960) |
| Cell size | 4.65 × 4.65 micron |
| Lens Mount | C-Mount |
| Digital Interface | Firewire IEEE 1394 |
| Digital Transfer Rate | 400 Mps |
| Electronic Shutter | Digital control to 1/100000 |
| Gain Control | 0-18 dB |
| Power consumption | 3 W |
| Dimensions | 44 × 33 × 116 mm |
| Weight | 250 grams |
| Shock Resistance | 70 G |
| Operating Temperature | −5 to 45° C. |

Each of the four digital camera electronic shutters is set specifically for the lighting conditions and terrain reflectivity at each mission area. The shutters are set by overflying the mission area and automatically adjusting the shutters to achieve an 80-count average brightness for each camera. The shutters are then held fixed during operational imagery collection.

Each of the cameras is outfitted with a different precision bandpass filter so that each operates in a different wavelength range. In the exemplary embodiment, the filters are produced by Andover Corporation, Salem, N.H. The optical filters each have a 25-mm diameter and a 21-mm aperture, and are each fitted into a filter ring and threaded onto the front of the lens of a different one of the cameras, completely covering the lens aperture. The nominal filter specifications for this example are shown in Table 2, although other filter center wavelengths and bandwidths may be used.

TABLE 2

| Color | Center wavelength | Bandwidth | f-stop |
|---|---|---|---|
| Blue | 450 microns | 80 microns | 4 |
| Green | 550 microns | 80 microns | 4 |
| Red | 650 microns | 80 microns | 4 |
| Near-Infrared | 850 microns | 100 microns | 2.8 |

The camera lenses in this example are compact C-mount lenses with a 12-mm focal length. The lenses are adjusted to infinity focus and locked down for each lens/filter/camera combination. The f-stop (aperture) of each camera may also be preset and locked down at the value shown in Table 2.

In the current example, a camera lens 12-mm focal length and ½-in CCD array format results in a field-of-view (FOV) of approximately 28.1 degrees in crossrange and 21.1 degrees in downrange. The “ground-sample-distance” (GSD) of the center camera pixels is dictated by the camera altitude “above ground level” (AGL), the FOV and number of pixels. An example ground-sample-distance and image size is shown below in Table 3 for selected altitudes AGL. Notably, the actual achieved ground-sample-distance is slightly higher than the ground-sample-distance at the center pixel of the camera due to the geometry and because the camera frames may not be triggered when the camera boresight is exactly vertical. For example, with a pixel at 24 degrees off the vertical, the increase in the ground-sample-distance is approximately 10%.

TABLE 3

| Altitude | GSD | Image Width | Image height | Area |
|---|---|---|---|---|
| (AGL ft) | (m/ft) | (m/ft) | (m/ft) | (acre/mi²) |
| 500 | 0.060/0.196 | 76.3/250.3 | 56.7/186.0 | 1.1/0.0017 |
| 1000 | 0.119/0.391 | 152.6/500.5 | 113.4/372.0 | 4.3/0.0067 |
| 2000 | 0.238/0.782 | 305.1/1001.0 | 226.8/744.1 | 17.1/0.0267 |
| 3000 | 0.357/1.173 | 457.7/1501.5 | 340.2/1116.1 | 38.5/0.060 |
| 4000 | 0.477/1.564 | 610.2/2002.0 | 453.6/1488.1 | 68.4/0.107 |
| 6000 | 0.715/2.346 | 915.3/3003.1 | 680.4/2232.2 | 153.9/0.240 |
| 8000 | 0.953/3.128 | 1220.4/4004.1 | 907.2/2976.3 | 273.6/0.427 |
| 10000 | 1.192/3.910 | 1525.6/5005.1 | 1134.0/3720.3 | 427.5/0.668 |

In the example system, the cameras of the camera assembly are given an initial calibration and, under operational conditions, the “band-alignment” of the single-frame imagery is monitored to determine the need for periodic re-calibrations. In this context, band-alignment refers to the relative boresight alignment of the different cameras, each of which covers a different optical band. Once the cameras are mounted together, precisely fixed in position relative to one another in the camera assembly, some misalignments will still remain. Thus, the final band alignment is performed as a post-processing technique. However, the adjustments made to the relative images relies on an initial calibration.

Multi-camera calibration is used to achieve band alignment in the present invention, both prior to flight and during post-processing of the collected image data. The preflight calibration includes minor adjustments of the cameras relative positioning, as is known in the art, but more precise calibration is also used that addresses the relative optical aberrations of the cameras as well. In the invention, calibration may involve mounting the multi-camera assembly at a prescribed location relative to a precision-machined target array. The target array is constructed so that a large number of highly visible point features, such as white, circular points, are viewed by each of the four cameras. The point features are automatically detected in two dimensions to sub-pixel accuracy within each image using image processing methods. In an example calibration, a target might have a 9×7 array of point features, with a total of 28 total images being taken such that a total of 1764 total features are collected during the calibration process. This allows any or all of at least nine intrinsic parameters to be determined for each of the four discrete cameras. In addition, camera relative position and attitude are determined to allow band alignment. The nine intrinsic parameters are: focal lengths (2), radial aberration parameters (2), skew distortion (1), trapezoidal distortion (2), and CCD center offset (2).

The camera intrinsic parameters and geometric relationships are used to create a set of unit vectors representing the direction of each pixel within a master camera coordinate system. In the current example, the “green” camera is used as the master camera, that is, the camera to which the other cameras are aligned, although another camera might as easily serve as the master. The unit vectors (1280*960*4 vectors) are stored in an array in the memory of controller 20, and are used during post-processing stages to allow precision georegistration. The array allows the precision projection of the camera pixels along a ray within the camera axes. However, the GPS/IMU integration process computes the attitude and position of the IMU axes, not the camera axes. Thus the laboratory calibration also includes the measurement of the camera-to-IMU misalignments in order to allow true pixel georegistration. The laboratory calibration process determines these misalignment angles to sub-pixel values.

In one example of camera-to-camera calibration, a target is used that is eight feet wide by six feet tall. It is constructed of two-inch wide aluminum bars welded at the corners. The bars are positioned such that seven rows and six columns of individual targets are secured to the bars. The individual targets are made from precision, bright white, fluoropolymer washers, each with a black fastener in the center. The holes for the center fastener are precisely placed on the bars so that the overall target array spacing is controlled to within one millimeter. The bars are painted black, a black background is placed behind the target, and the lighting in the room is arranged to ensure a good contrast between the target and the background. The target is located in a room with a controlled thermal environment, and is supported in such a way that it may be rotated about a vertical axis or a horizontal axis (both perpendicular to the camera viewing direction). The camera location remains fixed, and the camera is positioned to allow it to view the target at different angles of rotation. In this example, the camera is triggered to collect images at seven different rotational positions, five different vertical rotations and two different horizontal rotations. The twenty-eight collected images (four cameras at seven different positions) are stored in a database.

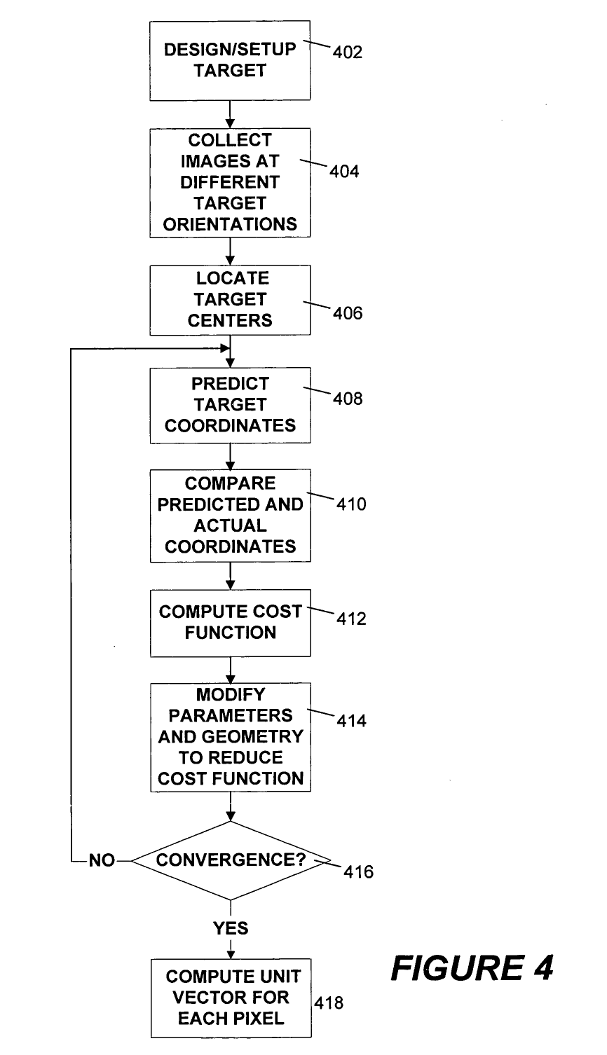

The general steps for camera-to-camera calibration according to this example are depicted in FIG. 4. The cameras are prepared by shimming each of them (other than the master camera) so that its pitch, roll and yaw alignment is close to that of the master camera. After target setup (step 402), the cameras are used to collect image data at different target orientations, as discussed above (step 404). The data is then processed to locate the target centers in the collected images (step 406). In this step, a mathematical template is used to represent each target point, and is correlated across each entire image to allow automatic location of each point. The centroid of the sixty-three targets on each image is located to approximately 0.1 pixel via the automated process, and identified as the target center for that image. The target coordinates are then all stored in a database.

At some time, typically prior to the image data collection, a mathematical model is formulated that is applicable for each camera of the multi-camera set. This model represents (using unknown parameters) the physical anomalies that may be present in each lens/camera. The parameters include (but are not necessarily limited to), radial aberration in the lens (two parameters), misalignment of the charge coupled device (“CCD”) array within the camera with respect to the optical boresight (two parameters), skew in the CCD array (1 parameter), pierce-point of the optical boresight onto the CCD array (two parameters), and the dimensional scale factor of the CCD array (two parameters). These parameters, along with the mathematics formulation, provide a model for the rays that emanate from the camera focal point through each of the CCD cells that form a pixel in the digital image. In addition to these intrinsic parameters, there are additional parameters that come from the geometry of the physical relationship among the cameras and the target. These parameters include the position and attitude of three of the cameras with respect to the master (e.g., green) camera. This physical relationship is known only approximately and the residual uncertainty is estimated by the calibration process. Moreover, the geometry of the master camera with respect to the target array is only approximately known. Positions and attitudes of the master camera are also required to be estimated during the calibration in order to predict the locations of the individual targets. Using this information regarding the position and attitude of the master camera relative to the target array, the relative position and orientation of each camera relative to the master camera, and the intrinsic camera model, the location coordinates of the individual targets is predicted (step 408).

Since the actual location of the targets is known, the unknown parameters in the camera model may be adjusted until the errors are minimized. The actual coordinates are compared with the predicted coordinates (step 410) to find the prediction errors. In the present example, an optimization cost function is then computed from the prediction errors (step 412). A least squares optimization process is then used to individually adjust the unknown parameters until the cost function is minimized (step 414). In the present example, a Levenburg-Marquart optimization routine is employed, and used to directly determine eighty-seven parameters, including the intrinsic model parameters for each camera and the relative geometry of each camera. The optimization process is repeated until a satisfactory level of “convergence” is reached (step 416). The final model, including the optimized unknown parameters, is then used to compute a unit vector for each pixel of each camera (step 418). Since the cameras are all fixed relative to one another (and the master camera), the mathematical model determined in the manner described above may be used, and reused, for subsequent imaging.

In addition to the calibration of the cameras relative to one another, the present invention also provides for the calibration of the cameras to the IMU. The orientation of the IMU axes is determined from a merging of the IMU and GPS data. This orientation may be rotated so that the orientation represents the camera orthogonal axes. The merging of the IMU and GPS data to determine the attitude and the mathematics of the rotation of the axes set is known in the art. However minor misalignments between the IMU axes and the camera axes must still be considered.

The particular calibration method for calibrating the IMU relative to the cameras may depend on the particular IMU used. An IMU used with the example system describe herein is available commercially. This IMU is produced by BAE Systems, Hampshire, UK, and performs an internal integration of accelerations and rotations at sample rates of approximately 1800 Hz. The integrated accelerations and rotation rates are output at a rate of 110 Hz and recorded by the controller 20. The IMU data are processed by controller software to provide a data set including position, velocity and attitude for the camera axes at the 110 Hz rate. The result of this calculation would drift from the correct value due to attitude initialization errors, except that it is continuously “corrected” by the data output by the GPS receiver. The IMU output is compared with once-per-second position and velocity data from the GPS receiver to provide the correction for IMU instrument errors and attitude errors.

In general, the merged IMU and GPS data provide an attitude measurement with an accuracy of less than 1 mrad and smoothed positions of less than 1 m. The computations of the smoothed attitude and position are performed after each mission using companion data from a GPS base station to provide a differential GPS solution. The differential correction process improves GPS pseodorange errors from approximately 3 m to approximately 0.5 m, and improves integrated carrier phase errors from 2 mm to less than 1 mm. The precision attitude and position are computed within a World Geodetic System 1984 (WGS-84) reference frame. Because the camera frames are precisely triggered at IMU sample times, the position and attitude of each camera frame is precisely determined. The specifications of the IMU used with the current example are provided below in Table 4.

TABLE 4

| | |
|---|---|
| Vendor | BAE Systems |
| Technology | Spinning mass multisensor |
| Gyro bias | 2 deg/hr |
| Gyro g-sensitivity | 2 deg/hr/G |
| Gyro scale factor error | 1000 PPM |
| Gyro dynamic range | 1000 deg/sec |
| Gyro Random Walk | 0.07 deg/rt-hr |
| Accelerometer bias | 0.60 milliG |
| Accelerometer scale factor error | 1000 PPM |
| Accelerometer Random Walk | 0.6 ft/s/rt-hr |
| Axes alignments | 0.50 mrad |
| Power Requirements | 13 W |
| Temperature range | −54 to +85 deg C |

The GPS receiver operates in conjunction with a GPS antenna that is typically located on the upper surface of the aircraft. In the current example, a commercially available GPS system is used, and is produced by BAE Systems, Hampshire, UK. The specifications of the twelve-channel GPS receiver are provided below in Table 5.

TABLE 5

| Vendor | Bae Superstar |
|---|---|
| Channels | 12 parallel channels - all-in-view |
| frequency | L1 - 1,575.42 MHz |
| Acceleration/jerk | 4 Gs/2 m/sec 2 |
| Time-To-first-fix | 15 sec w/current almanac |
| Re-acquisition time | <1 sec |
| Power | 1.2 W at 5 V |
| Backup power | Supercap to maintain almanac |
| Timing accuracy | +/−200 ns typical |
| Carrier phase stability | <3 mm (no differential corrections) |
| Physical | 1.8″ × 2.8″ × 0.5″ |
| Temperature | −30 to +75 deg C operational |
| Antenna | 12 dB gain active (5 V power) |

Within the IMU, the accelerometer axes are aligned with the gyro axes by the IMU vendor. The accelerometer axes can therefore be treated as the IMU axes. The IMU accelerometers sense the upward force that opposes gravity, and can therefore sense the orientation of the IMU axes relative to a local gravity vector. Perhaps more importantly, the accelerometer triad can be used to sense the IMU orientation from the horizontal plane. Thus, if the accelerometers sense IMU orientation from a level plane, and the camera axes are positioned to be level, then the orientation of the IMU relative to the camera axes can be determined.

For calibration of the IMU to the cameras, a target array is used and is first made level. The particular target array used in this example is equipped with water tubes that allow a precise leveling of the center row of visible targets. In addition, a continuation of this water leveling process allows the placement of the camera CCD array in a level plane containing the center row of targets. The camera axes are made level by imaging the target, and by placing a center row of camera pixels exactly along a center row of targets. If the camera pixel row and the target row are both in a level plane, then the camera axes will be in a level orientation. Constant zero-input biases in the accelerometers can be canceled out by rotating the camera through 180°, repeatedly realigning the center pixel row with the center target row, and differencing the respective accelerometer measurements.

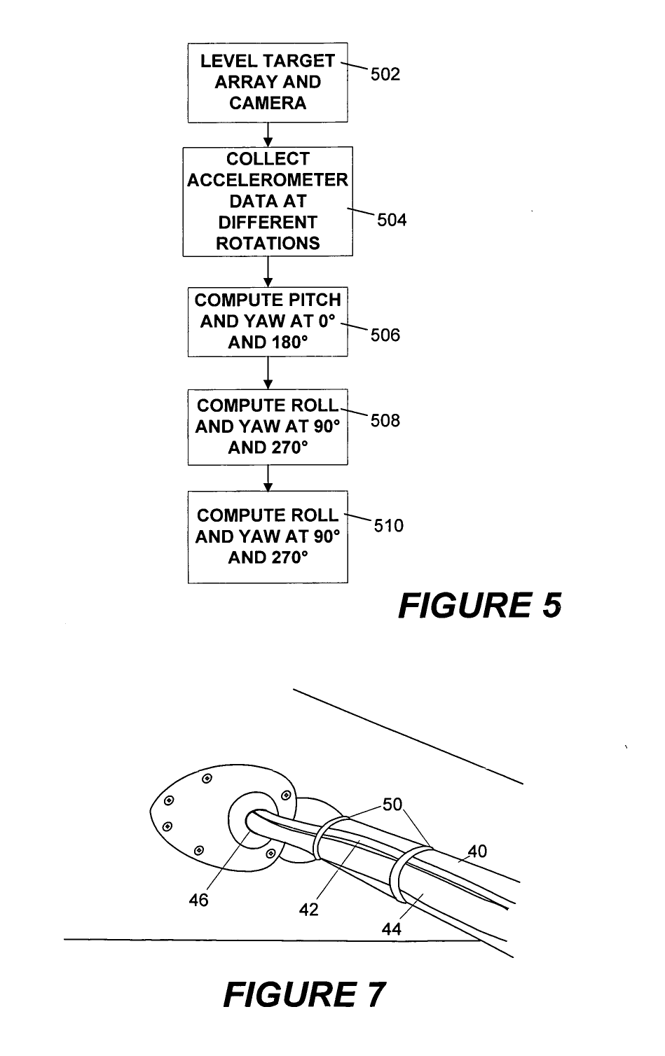

The general steps of IMU-to-camera calibration are shown in FIG. 5. After the leveling of the target array and the camera as described above (step 502), accelerometer data is collected at different rotational positions (step 504). In this example, data is collected at each of four different relative rotations about an axis between the camera assembly and the target array, namely, 0°, 90°, 180° and 270°. With the data collection at the 0° and 180° rotations, two of the angular misalignments, pitch and a first yaw measurement, may be determined (step 508). The 90° and 270° rotations also provide two misalignments, allowing determination of roll and a second yaw measurement (step 510). With each pair of measurements, the data from the two positions are differenced to remove the effects of the accelerometer bias. The two yaw measurements are averaged to obtain the final value of yaw misalignment.

The current example makes use of an 18-lb computer chassis that contains the controller 20. Included in the controller are a single-board computer, a GPS/IMU interface board, an IEEE 1394 serial bus, a fixed hard drive, a removable hard drive and a power supply. The display 28 may be a 10.4″ diagonal LCD panel with a touchscreen interface. In the present example, the display provides 900 nits for daylight visibility. The display is used to present mission options to the user along with the results of built-in tests. Typically, during a mission, the display shows the aircraft route as well as a detailed trajectory over the mission area to assist the pilot in turning onto the next flight line.

In the example system, the steering bar 26 provides a 2.5″×0.5″ analog meter that represents a lateral distance of the aircraft relative to the intended flight line. The center portion of the meter is scaled to ±25 m to allow precision flight line control. The outer portion of the meter is scaled to ±250 m to aid in turning onto the flight line. The meter is accurate to approximately 3 m based upon the GPS receiver. Pilot steering is typically within 5 m from the desired flight line.

The collection of image data using the present invention may also make use of a number of different tools. Mission planning tools make use of a map-based presentation to allow an operator to describe a polygon containing a region of interest. Other tools may also be included that allow selection of more complex multi-segment image regions and linear mission plans. These planning tools, using user inputs, create data files having all the information necessary to describe a mission. These data files may be routed to the aviation operator via the Internet or any other known means.

Setup software may also be used that allows setup of a post-processing workstation and creation of a dataset that may be transferred to an aircraft computer for use during a mission. This may include the preparation of a mission-specific digital elevation model (DEM), which may be accessed via the USGS 7.5 min DEM database or the USGS 1 deg database, for example. The user may be presented with a choice of DEMs in a graphical display format. A mission-specific data file architecture may be produced on the post-processing workstation that receives the data from the mission and orchestrates the various processing and client delivery steps. This data may include the raw imagery, GPS data, IMU data and camera timing information. The GPS base station data is collected at the base site and transferred to the workstation. Following the mission, the removable hard drive of the system controller may be removed and inserted into the post-processing workstation.

A set of software tools may also be provided that is used during post-processing steps. Three key steps are in this post-processing are: navigation processing, single-frame georegistration, and mosaic preparation. The navigation processing makes use of a Kalman filter smoothing algorithm for merging the IMU data, airborne GPS data and base station GPS data. The output of this processing is a “time-position-attitude” (.tpa) file that contains the WGS-84 geometry of each triggered frame. The “single-frame georegistration” processing uses the camera mathematical model file and frame geometry to perform the ray-tracing of each pixel of each band onto the selected DEM. This results in a database of georegistered three-color image frames with separate images for RGB and Near-IR frames. The single-frame georegistration step allows selection of client-specific projections including geodetic (WGS-84), UTM, or State-Plane. The final step, mosaic processing, merges the georegistered images into a single composite image. This stage of the processing provides tools for performing a number of operator-selected image-to-image color balance steps. Other steps are used for sun-angle correction, Lambertian terrain reflectivity correction, global image tonal balancing and edge blending.

A viewer application may also be provided. The viewer provides an operator with a simple tool to access both the individual underlying georegistered frames as well as the mosaicked image. Typically, the mosaic is provided at less than full resolution to allow rapid loading of the image. With the viewer, the client can use the coarse mosaic as a key to access full-resolution underlying frames. This process also allows the client access to all the overlap areas of the imagery. The viewer provides limited capability to perform linear measurement and point/area feature selection and cataloging of these features to a disk file. It also provides a flexible method for viewing the RGB and Near-IR color imagery with rapid switching between the colors as an aid in visual feature classification.

Additional tools may include a laboratory calibration manager, that manages the image capture during the imaging of the test target, performs the image processing for feature detection, and performs the optimization process for determining the camera intrinsic parameters and alignments. In addition, a base station data collection manager may be provided that provides for base station self-survey and assessment of a candidate base station location. Special methods are used to detect and reject multi-path satellite returns.

An alternative embodiment of the invention includes the same components as the system described above, and functions in the same manner, but has a different camera assembly mounting location for use with certain low wing aircraft. Shown in FIG. 6 is the camera assembly 12 mounted to a “Mooney” foot step, the support 40 for which is shown in the figure. In this embodiment, the cabling 42, 44 for the unit is routed through a pre-existing passage 46 into the interior of the cabin. This cabling is depicted in more detail in FIG. 7. As shown, cable 44 and cable 46 are both bound to the foot step support by cable ties 50, and passed through opening 46 to the aircraft interior.

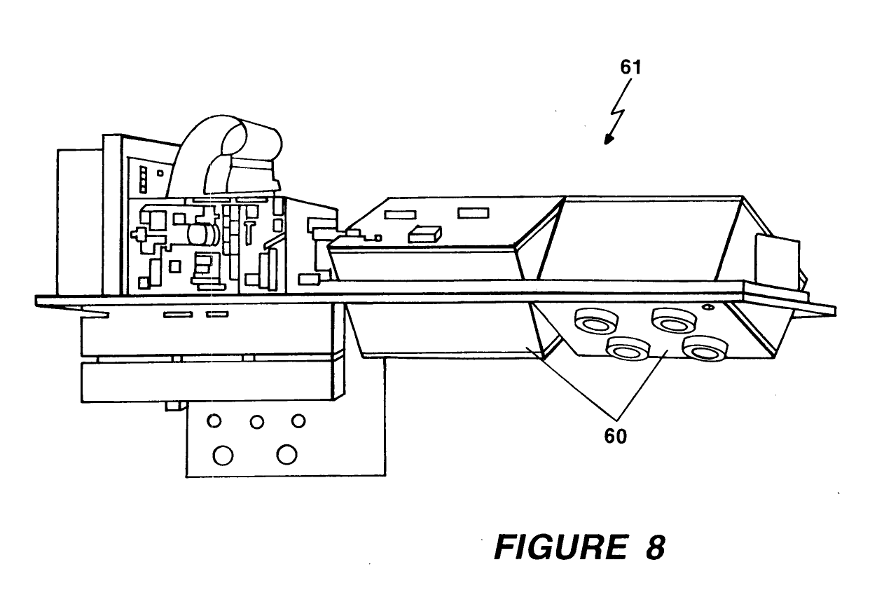

In still another embodiment, a modular camera arrangement is used. FIG. 8 shows, schematically, a mounting bracket on which are mounted two camera modules 60, each having four cameras mounted in a “square” pattern. The two modules are oriented in different directions, such that each set of cameras covers a different field to provide a relatively large field of view. Although the configuration shown in the figure makes use of two camera modules, those skilled in the art will recognize that additional cameras may be used either to further expand the field of view, or to increase the number of pixels within a fixed field of view. Other components 61 may also be mounted to the mounting frame, adjacent to the camera modules, such as the IMU, GPS boards and an IMU/GPS/camera-trigger synchronization board. Each of the camera modules 60 may be easily removed and replaced allowing simple access for repair or exchanging of camera modules with different imaging capabilities.

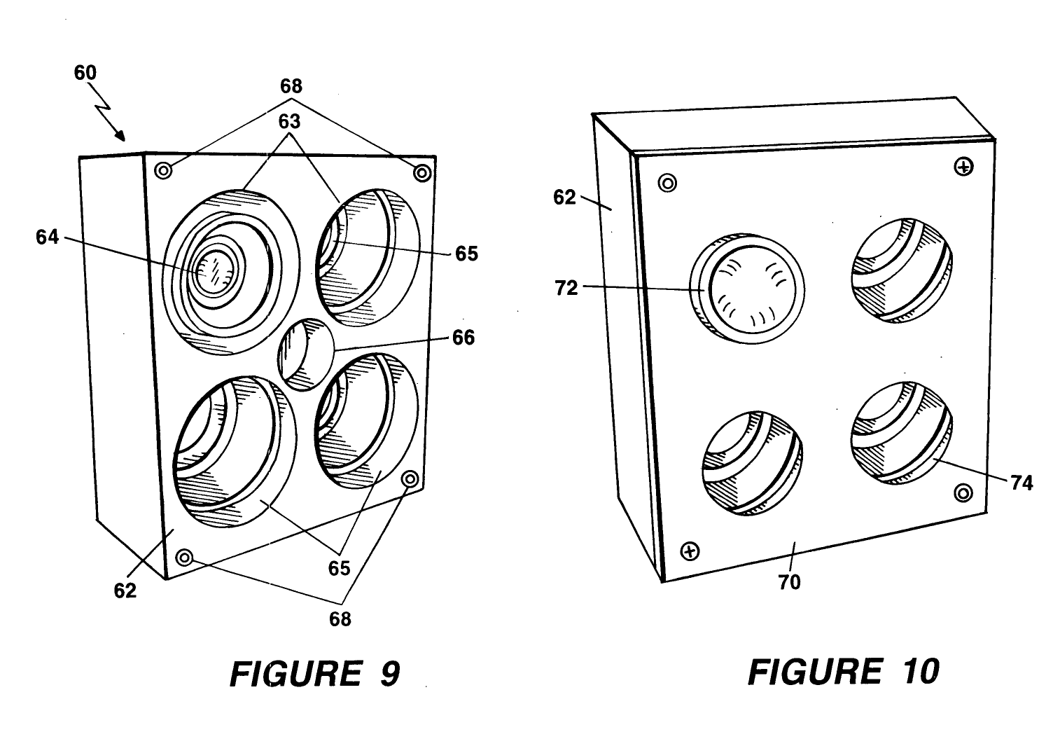

The camera modules 60 each include a mounting block 62 in which four lens cavities are formed. An example of such a block 62 is shown in FIG. 9. In the embodiment shown, the mounting block 62 is a monolithic block of aluminum into which the desired lens cavities 63 are bored with precisely parallel axes, so that the optical axes of lenses located in the cavities will likewise be precisely parallel. For clarity, the figure shows the mounting block with three of the lens cavities vacant, while a lens 64 occupies the remaining cavity. Obviously, in operation, a lens would be located in each of the cavities 63. In this example, screw threads 65 cut into each of the cavities mesh with screw threads on the outside of the lenses to hold them in place. However, it will be recognized that other means of fixing the lenses to the block may be used.

As shown in FIG. 9, each of the lens cavities extends all of the way through the block 62. An additional cavity 66 is bored only part of the way through the block from the “front side” of the block to form a receptacle for a desiccant material. The face of the block 62 shown in FIG. 9 is referred to as the “front side” because it faces the direction of the target being imaged. The desiccant receptacle is discussed below in conjunction with the camera filter retainer, which is attached to the front of the block via bolts that mesh with the threads in bolt holes 68 also cut into the front of the block.

Shown in FIG. 10 is the mounting block 62 with a filter retainer 70 bolted to the front of it. Like the block 62, the filter retainer may be formed of a single piece of material, such as aluminum. For clarity, the figure shows the filter retainer with only two bolts in place, and only one lens filter 72, although it will be understood that, in operation, all four bolts would be securing the retainer 70 to the mounting block 62, and lenses would be located in each of the four filter mounting bores 74. The bores are aligned with the lens bores in the mounting block 62 such that a filter 72 mounted in a mounting bore 74 filters light received by a lens behind it. Each of the filter bores has screw threads cut into it that mesh screw threads on the outside of each filter, thus allowing the filters to be tightly secured to the retainer, although other means of securing the filters may also be used.

In the example shown, an airtight chamber is formed between the filter retainer 70 and the mounting block 62. Each of the lenses mounted in the block 62 has an airtight seal against the block surface, and each of the filters mounted in the retainer 70 has an airtight seal against the retainer surface. To ensure an airtight seal between the block 62 and the retainer, an elastic gasket, with appropriate cutouts for the lens and bolt regions, may be used seal along the edges of the block 62 and the retainer 70. To minimize moisture accumulation in the region between the block and the retainer, a desiccant material is located in the desiccant receptacle shown in FIG. 9. The airspace between the block and the retainer may also be conditioned during assembly of the module. By heating the block 62 and/or retainer 70 before or during assembly, moisture is driven off the surfaces of the block and retainer, and the air in the airspace between them expands. Once assembled, an airtight seal is formed, and the cooling of the air in the airspace results in a vacuum being drawn therein. This reduced quantity of air molecules in the airtight space, and helps to minimize the occurrence of fogging or other interference with light passing from the filters to the lenses.

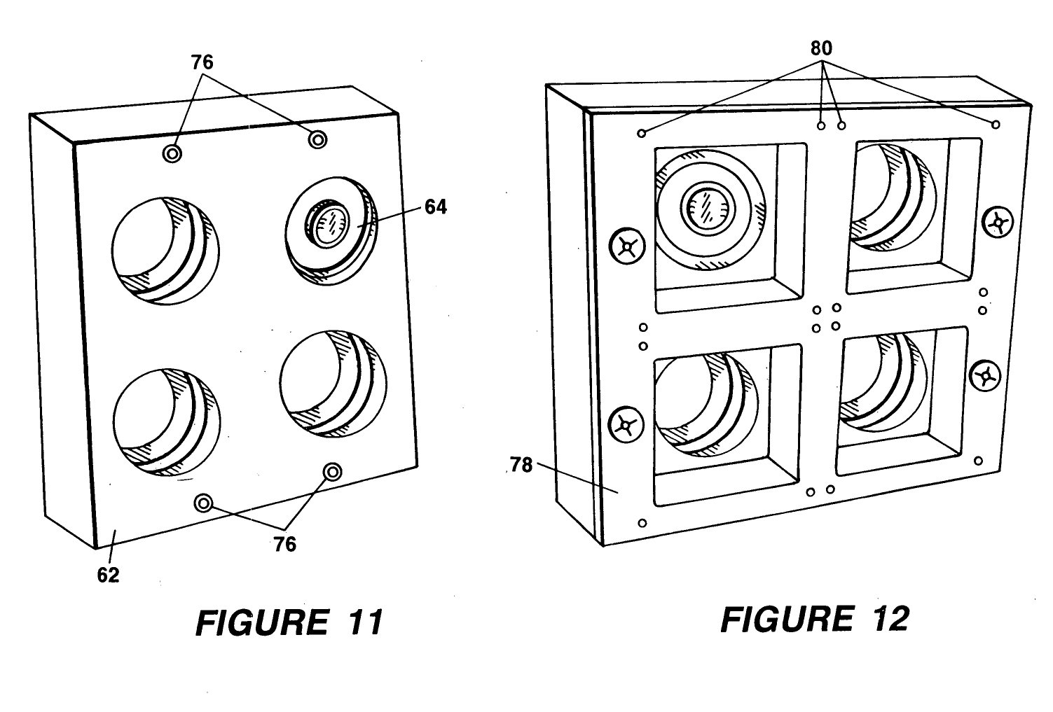

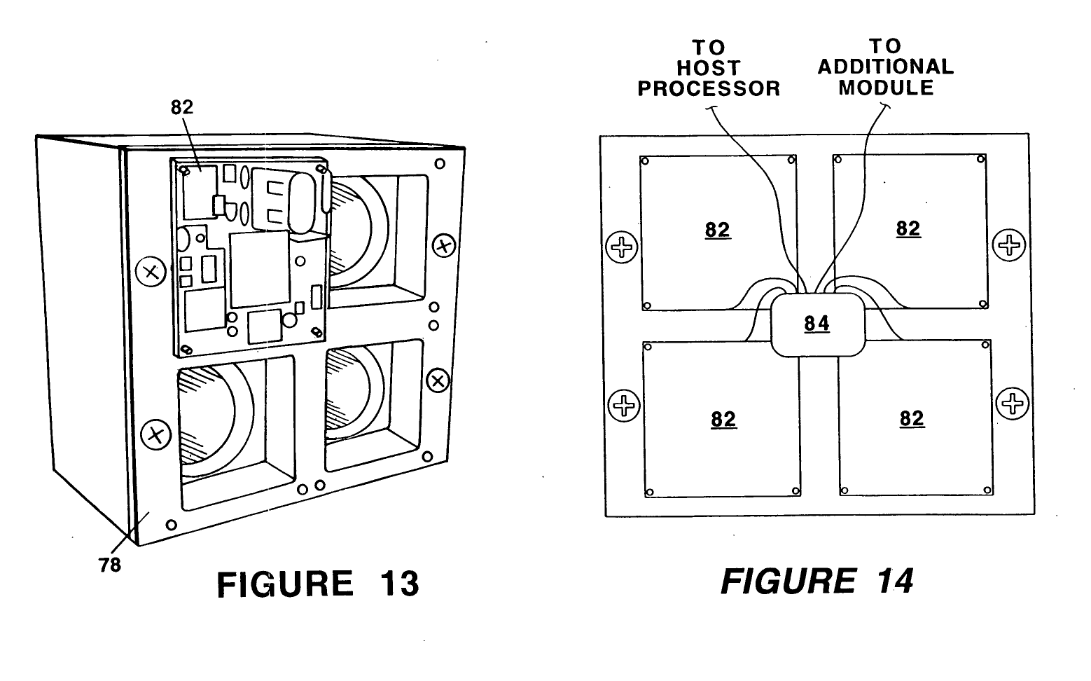

Imaging by each of the cameras of a module is done by a photosensitive charge-coupled device (CCD) mounted on a circuit board that is located behind one of the lenses of the module. FIG. 11 shows a back side of the mounting block 62 with one lens 64 mounted in the block. Four threaded bolt holes 76 are located on this side of the block and allow the attachment of a camera board spacer fixture. The spacer fixture 78 is shown in FIG. 12 bolted to the back of the block 62. The fixture 78 is the surface to which the CCD camera boards are attached, and it includes a number of threaded bolt holes included for this purpose. When bolted in place, each of the camera boards is aligned with its CCD imager directly behind the lens of the corresponding lens cavity. The fixture 78 is shown with a camera board 82 attached in FIG. 13.

The camera boards are connected to a host processor via digital data connections. In one embodiment, the data collection is done using a FIREWIRE® data format (FIREWIRE® is a registered trademark of Apple Computer, Inc., Cupertino, Calif.). FIREWIRE® is a commercial data collection format that allows serial collection of data from multiple sources. For this embodiment, all of the CCD cameras are FIREWIRE® compatible, allowing simplified data collection. The camera board 82 is shown in FIG. 13 with a rigid female connector extending from its surface. However, other, lower profile connectors may also be used for board connections, including those used to connect the FIREWIRE® data paths. This would provide the overall board with a significantly lower profile than that shown in the figure.

A schematic view of the rear side of a camera module is shown in FIG. 14, with each of four camera boards 82 in place. Located behind the boards is a six-port FIREWIRE® hub, to which each of six cables are connected. Four of the cables connect to respective camera boards, and provide a data path from the camera boards to the hub 84. The hub merges the data collected from the four boards, and transmits it over a fifth cable to a host processor that is running the data collection program. The sixth cable is provided to allow connection to a FIREWIRE® hub of an additional camera module. Data from all of the cameras of this additional module are transmitted over a single cable to the hub 84 shown in FIG. 14 which, in turn, transmits it to the host processor. Since the adjacent module is identical to the one shown in FIG. 9, it too has a six-port FIREWIRE® hub, and can therefore itself connect to another module. In this way, any desired number of modules may be linked together in a “daisy chain” configuration, allowing all of the data from the modules to be transmitted to the host processor over a single cable. This is particularly useful given the small number of available passages from the exterior to the interior of most aircraft on which the camera modules would be mounted. It also contributes to the modularity of the system by allowing the camera modules to be easily removed and replaced for repair or replacement with a module having other capabilities.

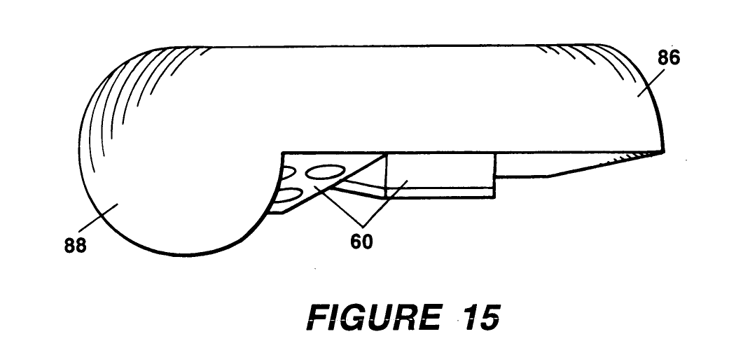

FIG. 15 shows a modular camera configuration (such as that of FIG. 9) mounted in an aerodynamic pod 86. This outer casing holds one or more camera modules 60 toward the front of the pod, while storing other components of the imaging system toward the rear, such as the IMU, dual GPS boards and an IMU/GPS/camera-trigger synchronization board. Those skilled in the art will recognize that the specific positions of these various components could be different, provided the camera modules have an unobstructed view of the target region below. The very front section 88 of the pod is roughly spherical in shape, and provides an aerodynamic shape to minimize drag on the pod.

The pod may be mounted in any of several different locations on an aircraft, including those described above with regard to other camera configurations. For example, the pod 86 can be mounted to the step mount on a landing gear strut in the same manner as shown for the camera assembly 12 in FIG. 2. Likewise, the pod may be mounted to a “Mooney” foot step, as shown for the assembly 12 in FIG. 6. In addition, a further mounting location might be near the top or the base of a wing strut of an aircraft such as that shown in FIG. 1. Depending on the particular application any one of these mounting arrangements may be used, as well as others, such as the mounting of the assembly to the underside of the aircraft body. In each of these mounting embodiments, a different path may be followed by the cable for the camera assembly to pass from the exterior of the plane to the interior. For a step mounting, the cable may be closed in the airplane door, as discussed above, or may pass through an existing opening, as shown in the Mooney aircraft embodiment of FIGS. 6 and 7. When the camera assembly and pod are mounted to a wing strut, the cable may be passed through any available access hole into the cockpit. When the pod is mounted on the underside of the aircraft body, it may be desirable to cut a pass-through hole at the mounting point to allow direct cable access to the cockpit.

While the invention has been shown and described with reference to a preferred embodiment thereof, it will be recognized by those skilled in the art that various changes in form and detail may be made herein without departing from the spirit and scope of the invention as defined by the appended claims.

What is claimed is:

1. An aerial imaging system comprising:
a image storage medium locatable within an aircraft;
a controller that controls the collection of image data and stores it in the storage medium; and
a camera assembly that collects image data from a region to be imaged and inputs it to the controller, the camera assembly comprising at least one multiple camera module having a rigid mounting block containing a plurality of parallel lens cavities in each of which a camera lens may be mounted, and a plurality of imaging photodetectors, each aligned to receive light from a different one of the camera lenses.
